(19) United States
(12) Patent Application Publication
(10) Pub. No.: US 2021/0030171 A1
(43) Pub. Date: Feb. 4, 2021

(54) INTERCHANGEABLE AND LOCKING FRAME VENEER

(71) Applicants: Brandon Hummons, Chicago, IL (US); Janae Hummons, Chicago, IL (US)

(72) Inventors: Brandon Hummons, Chicago, IL (US); Janae Hummons, Chicago, IL (US)

(21) Appl. No.: 16/941,275

(22) Filed: Jul. 28, 2020

Related U.S. Application Data
(60) Provisional application No. 62/880,875, filed on Jul. 31, 2019.

(51) Int. Cl. A47G 1/06; A47G 1/10

(52) U.S. Cl. CPC A47G 1/06; A47G 2001/0677; A47G 2001/0672; A47G 1/10

(57) ABSTRACT

An interchangeable and locking frame and veneer includes moving track components and interlocking corners. Tracks move within a respective component to expand to varying width and varying heights. The frame and veneer tracks have interlocking corners much like interlocking jigsaw geometries. A velcro or sticky adhesive substance disposed between the frame veneer and the existing frame keeps the components adjacent but available for easy interchanging of varying designs. Traditionally household items such as minors, televisions, and monitors come from the store with a very basic and standardized looking frame or border. This is problematic for individuals who desire to personalize their household items. The disclosure allows individuals to fully customize frameable objects in their household via a veneer design.

### CROSS REFERENCE

The present non-provisional patent application claims priority to the Provisional application 62/880,875 filed Jul. 31, 2019 by Brandon Hummons for an “Interchangeable and Locking Frame Veneer,” which is included in its entirety in the present application.

### SUMMARY OF THE INVENTION

An interchangeable and locking frame and veneer includes moving track components and interlocking corners. Tracks move within a respective component to expand to varying width and varying heights. The frame veneer tracks have interlocking corners much like interlocking jigsaw geometries. A velcro or sticky adhesive substance (not shown) disposed between the frame veneer and the existing frame keeps the components adjacent but available for easy interchanging for varying designs. Traditionally household items such as mirrors, televisions, and monitors come from the store with a very basic and standardized looking frame or border. This is problematic for individuals who desire to personalize their household items. The disclosure allows individuals to fully customize frameable objects in their household via a veneer design.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is an unassembled depiction of the components of the interchangeable and locking frame and veneer in accordance with an embodiment of the present disclosure.

FIG. 2 is an assembled depiction of the components of the interchangeable and locking frame and veneer in accordance with an embodiment of the present disclosure.

FIG. 3 is an unassembled depiction of the moving track components of the interchangeable and locking frame and veneer in accordance with an embodiment of the present disclosure.

FIG. 4 is an assembled depiction of the moving track components of the interchangeable and locking frame and veneer in accordance with an embodiment of the present disclosure.

FIG. 5 is a flow chart of a method for a moving track expandable frame and veneer in accordance with an embodiment of the present disclosure.

FIG. 6 is a flow chart of additional methods for a moving track expandable frame and veneer in accordance with an embodiment of the present disclosure.

Throughout the description, same reference numbers may be used to identify same or similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Dimensions detailed herein and in the drawings are intended to be a guide to nominal manufacturing dimensions. The detailed dimensions may vary by plus or minus ten percent taking into account manufacturing restraints and materials for various embodiments as recited, taught and suggested herein. The dimensions therefore are applicable to at least one embodiment but are not meant to be limiting to other embodiments of the disclosure.

The term ‘track,’ is used interchangeably and is considered synonymous with the terms ‘sleeve,’ and ‘channel,’ throughout the present disclosure. The term ‘locking,’ refers to an interlocking relation of ends of frame and veneer sides such as but not limited to dovetail, tongue and groove and jigsaw-like configurations. The terms ‘frame,’ and ‘veneer,’ refer to a frame veneer and to a frame and to a veneer both separately and combined.

The disclosure consists of 1) moving track frame and veneer components, 2) an Adhesive Strip for the veneer components 3) interlocking frame and veneer corners. The disclosure enables consumers to customize items in their home with frame veneers. Traditionally household items such as mirrors, televisions, and monitors come from the store with a very basic and standardized looking frame or border. This can be problematic for individuals who desire to personalize their household items. The disclosure is an ingenious and practical device that allows individuals to fully customize frameable objects in their household.

The disclosed frame and veneer is made out of four separate bars that interlock and latch together at corners to make one stylized frame. The frames come equipped with an adhesive strip that sticks Velcro to the object that the user decides to frame in order to make putting the frame veneer on as easy clipping it to the Velcro.

The disclosed frame and veneer may prove to be essential within the novelty industry as a means for consumers to customize frameable objects within their home. The disclosed frame and veneer is the only product of its kind to offer individuals a customizable frame for household electronics and objects. The disclosed frame and veneer is uniquely designed with a frame veneer that is made out of four separate bars with embodiments that include moving tracks for longer or taller frames that clip together with a Velcro attachment to non-moving portions of the bars that are assisted by an adhesive strip.

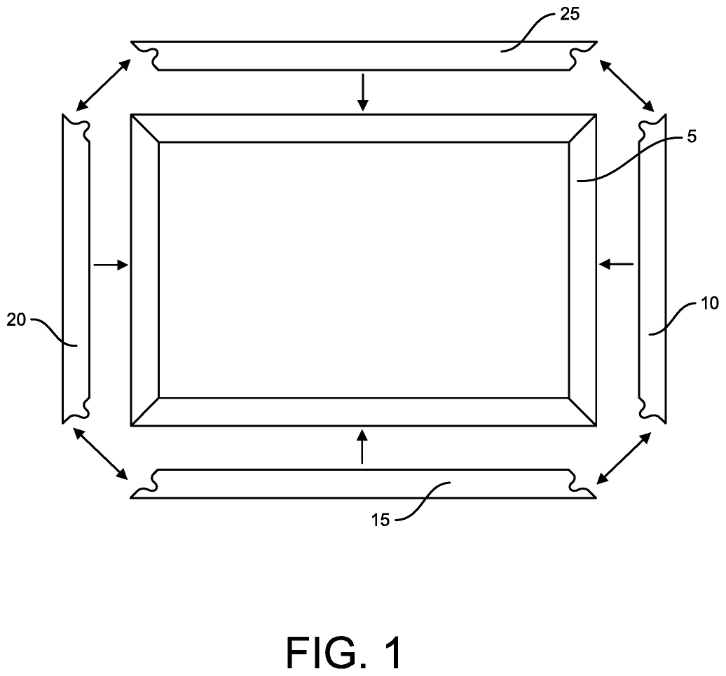

FIG. 1 is an unassembled depiction of the components of the interchangeable and locking frame and veneer in accordance with an embodiment of the present disclosure. The depicted embodiment shows an unassembled existing frame 5, a right side bar frame veneer 10, a bottom side bar frame veneer 15, a left side bar frame veneer 20 and a top side bar frame veneer 25. Each frame veneer bar has interlocking corners much like interlocking jigsaw geometries.

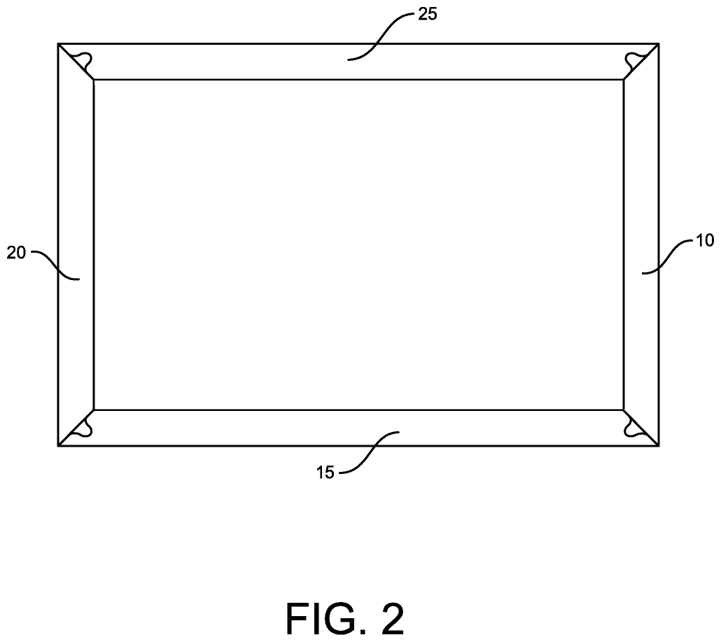

FIG. 2 is an assembled depiction of the components of the interchangeable and locking frame veneer in accordance with an embodiment of the present disclosure. The depicted embodiment shows an assembled existing frame 5, a right side bar frame veneer 10, a bottom side bar frame veneer 15, a left side bar frame veneer 20 and a top side bar frame veneer 25. Each frame veneer bar has interlocking corners much like interlocking jigsaw geometries. A velcro or sticky adhesive substance (not shown) disposed between the frame veneer and the existing frame keeps the components adjacent but available for easy interchanging.

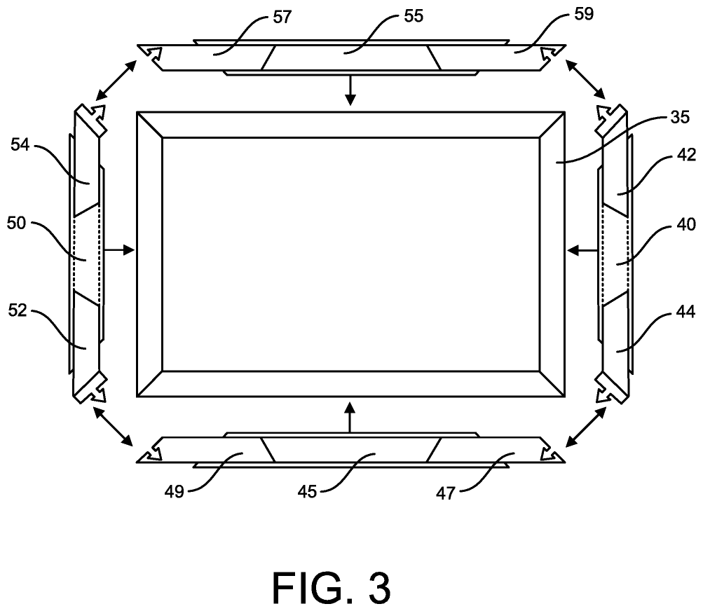

FIG. 3 is an unassembled depiction of the moving track components of the interchangeable and locking frame veneer in accordance with an embodiment of the present disclosure. The depicted embodiment shows an unassembled existing frame 35, a right side moving track frame veneer 40, a bottom side moving track frame veneer 45, a left side moving track frame veneer 50 and a top side moving track frame veneer 55. Tracks 42, 44, 47, 49, 52, 54, 57 and 59 move within a respective track to expand to varying width and varying heights. Each frame veneer track has interlocking corners much like interlocking jigsaw geometries.

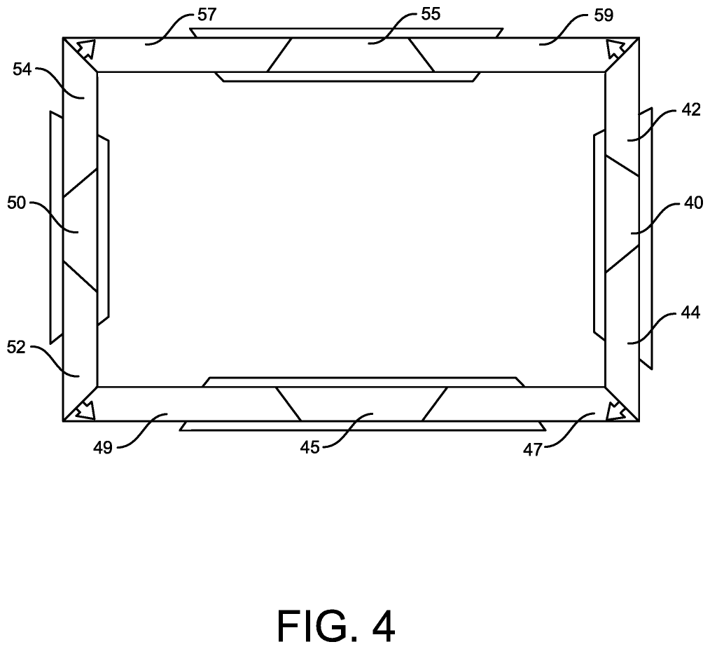

FIG. 4 is an assembled depiction of the moving track components of the interchangeable and locking frame veneer in accordance with an embodiment of the present disclosure. The depicted embodiment shows an assembled existing frame 35, a right side moving track frame veneer 40, a bottom side moving track frame veneer 45, a left side moving track frame veneer 50 and a top side moving track frame veneer 55. Tracks 42, 44, 47, 49, 52, 54, 57 and 59 move within a respective track to expand to varying width and varying heights. Each frame veneer track has interlocking corners much like interlocking jigsaw geometries. A velcro or sticky adhesive substance (not shown) disposed between the frame veneer and the existing frame keeps the components adjacent but available for easy interchanging.

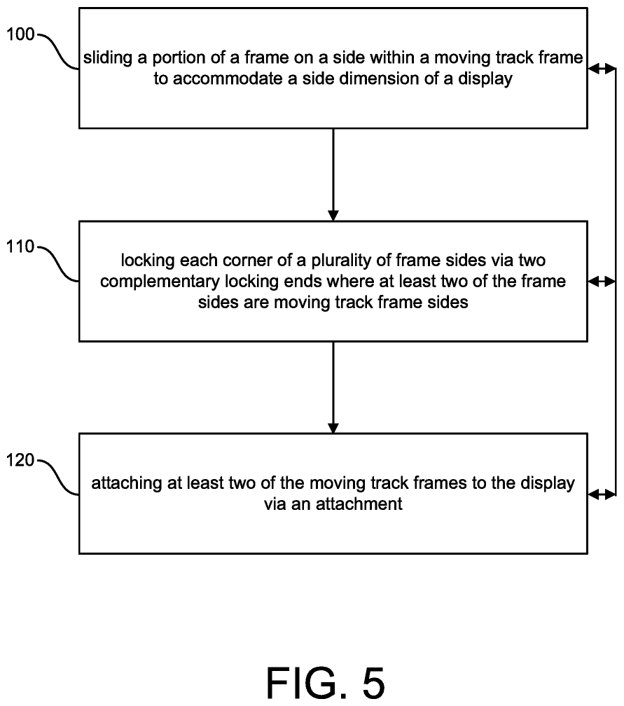

FIG. 5 is a flow chart of a method for a moving track expandable frame in accordance with an embodiment of the present disclosure. The method includes sliding 100 a portion of a frame on a side within a moving track frame to accommodate a side dimension of a display. The method also includes locking 110 each corner of a plurality of frame sides via two complementary locking ends where at least two of the frame sides are moving track frame sides. The method additionally includes attaching 120 at least two of the moving track frames to the display via an attachment.

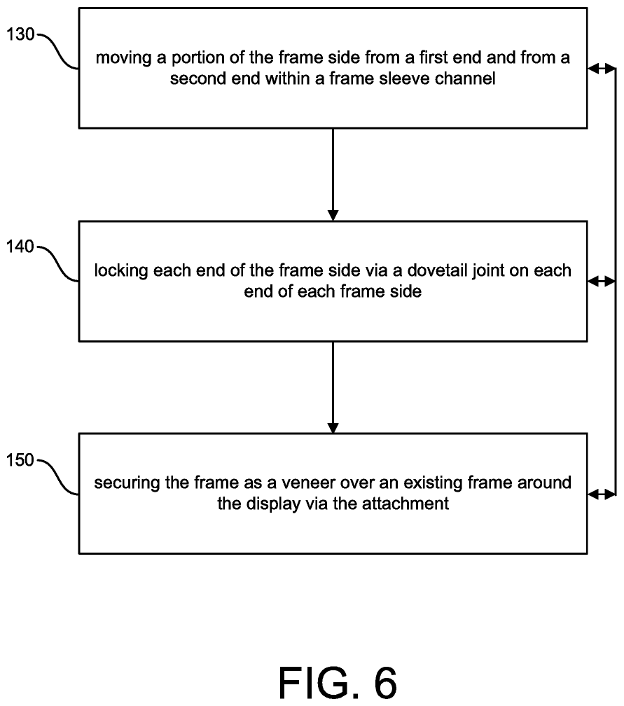

FIG. 6 is a flow chart of additional methods for a moving track expandable frame in accordance with an embodiment of the present disclosure. The embodiments of the method include moving 130 a portion of the frame side from a first end and from a second end within a frame sleeve channel. The embodiments also include locking 140 each end of the frame side via a dovetail joint on each end of each frame side. The embodiments additionally include securing 150 the frame as a veneer over an existing frame around the display via the attachment.

Further embodiments include interlocking each corner of the plurality of frame sides via a jigsaw-like configuration on a mitered end of each frame side and attaching the frame to the display via a complementary hook and loop attachment between the frame and the display.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention.

Accordingly, it is not intended that the disclosure be limited, except as by the specification and claims set forth herein.

What is claimed is:

1. A frame comprising:
a moving track frame on a side configured to provide a sliding expansion of a portion of the frame on the side within the moving track;
a complementary locking configuration at each corner of a plurality of frame sides where at least two of the frame sides are moving track frame sides; and
wherein at least two of the moving track frames comprise an attachment therefrom to a display.

2. The frame of claim 1, wherein the moving track frame comprises a frame sleeve configured to receive a portion of the frame from a first end and from a second end.

3. The frame of claim 1, wherein the moving track frame comprises a channel configured to receive a portion of the frame from a first end and from a second end thereof.

4. The frame of claim 1, wherein the complementary locking configuration comprises a tongue and a groove configuration on a mitered end of each frame side.

5. The frame of claim 1, wherein the complementary locking configuration comprises a dovetail configuration on a mitered end of each frame side.

6. The frame of claim 1, wherein the complementary locking configuration comprises a jigsaw-like configuration on a mitered end of each frame side.

7. The frame of claim 1, wherein the attachment comprises a complementary hook and loop attachment.

8. The frame of claim 1, wherein the attachment comprises a complementary magnet and metal attachment.

9. The frame of claim 1, wherein the attachment comprises a sticky adhesive.

10. The frame of claim 1, wherein the moving track frame on the side provides a sliding expansion of the portion of the frame side to double a total length thereof.

11. The frame of claim 1, wherein the display includes a picture, an electronic display, a work of art and a window.

12. The frame of claim 1, wherein the moving track frame is a frame veneer.

13. The frame of claim 1, wherein the complementary locking configuration at each corner is a frame veneer.

14. The frame of claim 1, wherein the frame is a frame veneer.

15. A method for providing a frame, the method comprising:
sliding a portion of a frame on a side within a moving track frame to accommodate a side dimension of a display;
locking each corner of a plurality of frame sides via two complementary locking ends where at least two of the frame sides are moving track frame sides; and
attaching at least two of the moving track frames to the display via an attachment.

16. The method of claim 15, further comprising moving a portion of the frame side from a first end and from a second end within a frame sleeve channel.

17. The method of claim 15, further comprising locking each end of the frame side via a dovetail joint on each end of each frame side.

18. The method of claim 1, further comprising securing the frame as a veneer over an existing frame around the display via the attachment.

19. The method of claim 1, further comprising interlocking each corner of the plurality of frame sides via a jigsaw-like configuration on a mitered end of each frame side.

20. The method of claim 1, further comprising attaching the frame to the display via a complementary hook and loop attachment between the frame and the display.
